(19) United States
(12) Patent Application Publication
(10) Pub. No.: US 2007/0046739 A1
(43) Pub. Date: Mar. 1, 2007

(54) Array type printhead and inkjet image forming apparatus including the same

(75) Inventors: Young-su Lee, Yongin-si (KR); Jae-cheol Lee, Hwaseong-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/493,659

(22) Filed: Jul. 27, 2006

(30) Foreign Application Priority Data
Sep. 1, 2005 (KR) 2005-81332

(51) Int. Cl. B41J 2/045

(52) U.S. Cl. 347/71

(57) ABSTRACT

An array type printhead includes a first member including a plurality of inflow holes through which inks of different colors flow, a second member including a plurality of channels formed on a top surface thereof to receive the inks of different colors from the plurality of inflow holes of the first member, and a plurality of outflow holes through which the received inks flow, a third member including a plurality of path grooves formed on a top surface thereof through which the inks of different colors flow from the second member, and a plurality of supply holes formed in corresponding ones of the plurality of path grooves, each supply hole to supply one head chip nozzle line with ink of one color, and at least one head chip mounted on a bottom surface of the third member and comprising a plurality of nozzles arranged in a plurality of lines in a lengthwise direction of the printhead corresponding to a widthwise direction of a printing medium to eject the inks of different colors, the first, second, and third members being layered on top of each other.

### CROSS-REFERENCE TO RELATED APPLICATIONS

This application claims priority under 35 U.S.C. §119(a) from Korean Patent Application No. 10-2005-0081332, filed on Sep. 1, 2005, in the Korean Intellectual Property Office, the disclosure of which is incorporated herein in its entirety by reference.

### BACKGROUND OF THE INVENTION

1. Field of the Invention

The present general inventive concept relates to an inkjet image forming apparatus, and more particularly, to an array type inkjet head and an inkjet image forming apparatus including the same.

2. Description of the Related Art

Recently, a wide array type inkjet image forming apparatus, which produces an image by ejecting ink onto a printing paper using a plurality of nozzles formed on a printhead in a widthwise direction of the printing paper, has been actively studied. Such a wide array inkjet image forming apparatus performs printing faster than a shuttle type inkjet image forming apparatus, which produces an image using an ink cartridge that moves forward and backward in the widthwise direction of the printing paper.

FIG. 1 is a perspective view illustrating a conventional array type printhead 10. Referring to FIG. 1, the conventional array type printhead 10 includes a substrate 12 formed of ceramic, and a plurality of head chips 15 on which a plurality of nozzles 17 are formed. The head chips 15 are arranged on a bottom surface of the substrate 12, which faces a printing paper (not illustrated), in a widthwise direction of the printing paper (not illustrated). The plurality of head chips 15 are arranged to form first, second, third, and fourth head chip lines CL1, CL2, CL3, and CL4. The nozzles 17 of the head chips 15 on the same head chip lines CL1, CL2, CL3, and CL4 eject ink of the same color. For instance, the nozzles 17 of the head chips 15 on the first head chip line CL1 may eject cyan (C) ink, the nozzles 17 on the second head chip line CL2 may eject magenta (M) ink, the nozzles 17 on the third head chip line CL3 may eject yellow (Y) ink, and the nozzles 17 on the fourth head chip line CL4 may eject black (K) ink. In the substrate 12, a manifold (not illustrated) formed of aluminum is included. The manifold forms an ink path through which ink flows from an ink tank (not illustrated) to the head chip 15.

However, the conventional printhead 10 requires at least three head chip lines to form a color image, and thus it is difficult to miniaturize the printhead 10 and an inkjet image forming apparatus including the printhead 10. Also, a manufacturing cost of the inkjet image forming apparatus including the printhead 10 increases due to the larger number of head chips 15 arranged in the at least three head chip lines.

Moreover, since materials for forming the substrate 12 and the manifold, that is, ceramic and aluminum, are expensive and hard to process to obtain high dimensional precision, a manufacturing cost of the image forming apparatus is increased.

### SUMMARY OF THE INVENTION

The present general inventive concept provides an array type printhead to eject ink of different colors from a single head chip, and an inkjet image forming apparatus including the array type printhead.

The present general inventive concept also provides an array type printhead formed of a polymer resin, and an inkjet image forming apparatus including the array type printhead.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing an array type printhead, including a first member including a plurality of inflow holes through which inks of different colors flow; a second member including a plurality of channels formed on a top surface thereof to receive the inks of different colors from the plurality of inflow holes of the first member, and a plurality of outflow holes through which the received inks flow; a third member including a plurality of path grooves formed on a top surface thereof through which the inks of different colors flow from the second member, and a plurality of supply holes formed in corresponding ones of the plurality of path grooves, each supply hole to supply one head chip nozzle line with ink of one color; and at least one head chip mounted on a bottom surface of the third member and comprising a plurality of nozzles arranged in a plurality of lines in a lengthwise direction of the printhead corresponding to a widthwise direction of a printing medium to eject the inks of different colors, the first, second, and third members being layered on top of each other.

The first, second, and third members may each include at least one polymer resin.

The polymer resin may be a liquid crystal polymer.

The first member may include a plurality of sub-channels formed on a bottom surface thereof and having an identical pattern as the plurality of channels formed on the top surface of the second member.

The second member may include a plurality of path grooves formed on a bottom surface thereof and having an identical pattern as the plurality of path grooves formed on the top surface of the third member.

The printhead may further include sealant layers formed between the bottom surface of the first member and the top surface of the second member, and between the bottom surface of the second member and the top surface of the third member, respectively, in order to prevent the inks of different colors from mixing with each other and/or to prevent ink leakage.

The printhead may further include ribs formed on edge portions of the top surface of the second member and on edge portions of the top surface of the third member to protrude from the second member and the third member, respectively, and grooves formed on edge portions of the bottom surface of the first member and on edge portions of the bottom surface of the second member to receive the ribs from the second member and the third member, respectively.

The plurality of channels of the second member may extend in parallel to each other in the lengthwise direction of the printhead.

The plurality of inflow holes of the first member may include four inflow holes through which inks of four different colors respectively flow to the second member, the plurality of channels of the second member may include four channels to receive the ink of four different colors flowing through the four inflow holes, respectively, and the at least one head chip may include four nozzle lines to eject the inks of the four different colors, respectively.

The at least one head chip may include a plurality of head chips arranged in the lengthwise direction of the printhead to form a head chip line, and each of the plurality of channels of the second member may include one or more outflow holes arranged at regular intervals to correspond to a length of the head chip line.

The plurality of path grooves may be repeatedly arranged in the third member in the lengthwise direction of the printhead.

The plurality of head chips may be arranged in a zigzag pattern along the head chip line, and a first set of path grooves to supply ink to a portion of the plurality of head chips arranged in a side of the head chip line and a second set of path grooves to supply ink to a portion of the plurality of head chips arranged in an opposite side of the head chip line are alternately formed in the top surface of the third member.

The at least one head chip may be include a plurality of head chip lines on which the plurality of head chips are arranged.

The foregoing and/or other aspects and utilities of the present general inventive concept may also be achieved by providing an array type inkjet printhead useable in an inkjet image forming apparatus, including a first member comprising a plurality of ink holes to receive corresponding ones of a plurality of differently-colored inks, a second member comprising a plurality of ink channels to communicate with the plurality of ink holes to receive corresponding ones of the plurality of differently-colored inks, a third member comprising at least one set of ink grooves to communicate with the plurality of ink channels to receive corresponding ones of the plurality of differently-colored inks, and at least one head chip comprising a plurality of nozzle lines to communicate with the at least one set of ink grooves to receive and eject corresponding ones of the plurality of differently-colored inks.

The first member may further include a plurality of ink sub-channels to communicate with corresponding ones of the plurality of ink holes and corresponding ones of the plurality of ink channels of the second member. The array type inkjet printhead may further include a plurality of ink chambers formed by the communication between the plurality of ink sub-channels of the first member and the plurality of ink channels of the second member to contain corresponding ones of the differently-colored inks.

The foregoing and/or other aspects and utilities of the present general inventive concept may also be achieved by providing an array type inkjet printhead useable in an inkjet image forming apparatus, including a plurality of storage spaces to store corresponding ones of a plurality of differently-colored inks, a plurality of outflow holes corresponding to the plurality of storage spaces to allow a flow of the plurality of differently-colored inks from the plurality of storage spaces, a plurality of ink grooves to receive corresponding ones of the plurality of differently-colored inks from the plurality of outflow holes, a plurality of supply holes corresponding to the plurality of ink grooves to supply the plurality of differently-colored inks from the plurality of supply holes, and a head chip comprising a plurality of nozzle lines to communicate with the plurality of supply holes to receive and eject corresponding ones of the plurality of differently-colored inks supplied by the plurality of supply holes.

The plurality of outflow holes may be located at predetermined intervals along a length of the printhead corresponding to a length of the head chip.

The foregoing and/or other aspects and utilities of the present general inventive concept may also be achieved by providing an inkjet ink cartridge useable in an image forming apparatus, including a plurality of ink tanks to store corresponding ones of a plurality of differently-colored inks, a plurality of negative pressure regulators corresponding to the plurality of ink tanks to regulate pressures thereof, and an array type inkjet printhead, including a first member comprising a plurality of ink holes to receive corresponding ones of the plurality of differently-colored inks from the plurality of ink tanks, a second member comprising a plurality of ink channels to communicate with the plurality of ink holes to receive corresponding ones of the plurality of differently-colored inks, a third member comprising at least one set of ink grooves to communicate with the plurality of ink channels to receive corresponding ones of the plurality of differently-colored inks, and at least one head chip comprising a plurality of nozzle lines to communicate with the at least one set of ink grooves to receive and eject corresponding ones of the plurality of differently-colored inks.

The foregoing and/or other aspects and utilities of the present general inventive concept may also be achieved by providing a printhead, including a member having a plurality of inflow holes disposed in a lengthwise direction to receive a plurality of different inks, and a plurality of channels each disposed in the lengthwise direction and connected to corresponding ones of the plurality of inflow holes to direct corresponding ones of the plurality of different inks in the lengthwise direction, a head chip having a plurality of nozzles, and another member disposed between the member and the head chip and having pass grooves to guide the different inks from the corresponding channels to the corresponding nozzles in a direction having an angle with the lengthwise direction.

The plurality of nozzles may include a plurality of sets of nozzles, each set of nozzles disposed on a plurality of parallel lines in the lengthwise direction, and the inflow holes may be disposed on the respective parallel lines. The pass grooves may be disposed parallel to each other in the direction to guide the corresponding different inks from the corresponding inflow holes to the corresponding nozzles. The pass grooves may include a first groove having a first length and a second groove having a second length in the direction. The first length may correspond to a distance between adjacent ones of the parallel lines, and the second length may correspond to a distance between two of the parallel lines disposed opposite to each other with respect to at least one of the parallel lines therebetween. Each of the pass grooves may be disposed to guide the corresponding different ink from a first position of one of the parallel lines to a second position of another one of the parallel lines, and the first position and the second position are disposed in a line of the lengthwise direction.

The printhead may further include a second head chip having a plurality of second nozzles, and the plurality of second nozzles may include a plurality of sets of second nozzles, each set disposed on a plurality of second parallel lines in the lengthwise direction. The printhead may further include second pass grooves disposed parallel to each other in the direction to guide the corresponding different ink from the corresponding ink channels to the corresponding second nozzles. Each of the pass grooves may provide a passage of a corresponding one of the different inks between a corresponding one of the channels and a predetermined number of the nozzles. The member may include a plurality of dividers formed between the adjacent channels to separate one of the channels from another one of the channels.

The another member may include a sealant disposed between the pass grooves to separate one of the pass grooves from another one of the pass grooves. The another member may include a second member having a plurality of sub-channels disposed in the lengthwise direction to communicate with the corresponding channels, and a plurality of outflow holes formed at a plurality of position along each sub-channel. The another member may further include a third member having a plurality of sub-grooves corresponding to the plurality of outflow holes to guide the different inks to the corresponding nozzles. The sub-channels, the outflow holes, and the sub-grooves may form the pass grooves.

The pass grooves may include a plurality of supply holes to guide the different inks to the corresponding nozzle. The plurality of supply holes may form patterns repeating along the lengthwise direction. The plurality of supply holes may be disposed on lines having an angle with the lengthwise direction. The supply holes may not overlap in the direction. At least two of the supply holes may overlap in the direction.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a perspective view illustrating a conventional array type printhead;

FIG. 2 is a cross-sectional view illustrating an inkjet image forming apparatus, according to an embodiment of the present general inventive concept;

FIG. 3 is an exploded perspective view illustrating top surfaces of component parts of an array type printhead of the image forming apparatus of FIG. 2, according to an embodiment of the present general inventive concept;

FIG. 4 is an exploded perspective view illustrating bottom surfaces of the component parts of the array type printhead illustrated in FIG. 3;

FIG. 5 is a plan view partially illustrating a top surface of a second member of the array type printhead illustrated in FIGS. 3 and 4, according to an embodiment of the present general inventive concept;

FIG. 6 is a plan view partially illustrating a top surface of a third member of the array type printhead illustrated in FIGS. 3 and 4, according to an embodiment of the present general inventive concept;

FIG. 7 is a plan view partially illustrating a bottom surface of the third member of the array type printhead illustrated in FIGS. 3 and 4, according to an embodiment of the present general inventive concept; and

FIG. 8 is a cross-sectional view illustrating the array type printhead illustrated in FIG. 3 taken along line VIII-VIII in FIG. 3.

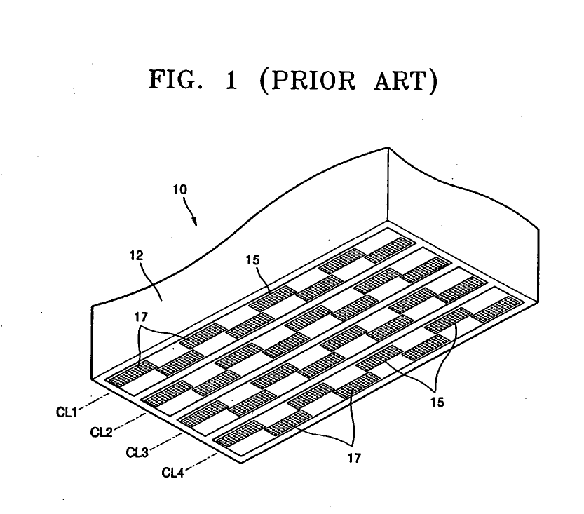

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

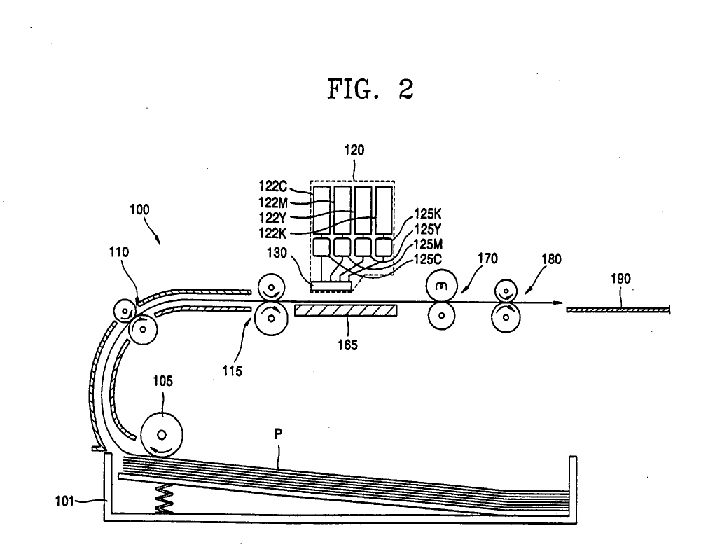

FIG. 2 is a cross-sectional view illustrating an inkjet image forming apparatus 100, according to an embodiment of the present general inventive concept. Referring to FIG. 2, the inkjet image forming apparatus 100 includes a conveying unit to convey printing media, such as a sheet of printing paper P, in one direction, and an array type printhead 130 to form an image by ejecting ink onto the printing paper P. The conveying unit includes feeding rollers 110 to convey the printing paper P to pass under the array type printhead 130, and discharge rollers 180 to discharge the printing paper P on which the image has been printed onto a discharge tray 190. Each of the feeding rollers 110 and the discharge rollers 180 include a driving roller and an idle roller, which are installed to contact each other, and the printing paper P passes between the driving roller and idle roller. Reference numeral 115 denotes registration rollers to align the printing paper P such that the image is formed on a desired portion of the printing paper P.

The inkjet image forming apparatus 100 includes a paper feeding cassette 101 in which sheets of printing paper P are stacked, and a pickup roller 105 to pick up a sheet of printing paper P from the paper feeding cassette 101. Furthermore, the inkjet image forming apparatus 100 includes a drier 170 to dry the image formed by ejecting ink onto the printing paper P Since the inkjet image forming apparatus 100 including the array type printhead 130 can print at a high speed, the sheets of printing paper P may not be sufficiently dried before being stacked in the discharge tray 190, thereby causing an ink smearing thereon. The drier 170, however, quickly dries the image to prevent printing failure due to such ink smearing.

The array type printhead 130 is disposed between the registration rollers 115 and the drier 170. An ink cartridge 120 includes the printhead 130, four ink tanks 122C, 122M, 122Y, and 122K, which can contain cyan (C) ink, magenta (M) ink, yellow (Y) ink, and black (K) ink, respectively, and four negative pressure regulators 125C, 125M, 125Y, and 125K. The negative pressure regulators 125C, 125M, 125Y, and 125K regulate a negative pressure of ink flowing from the four ink tanks 122C, 122M, 122Y, and 122K, respectively, to the printhead 130 to prevent air bubbles from entering the printhead 130 or an unnecessary leakage of the ink through nozzles 162 (see FIG. 8).

A platen 165 is disposed under the printhead 130 to support the printing paper P while the image is being formed on the printing paper P. The platen 165 to maintain a constant distance between the printhead 130 and the printing paper P.

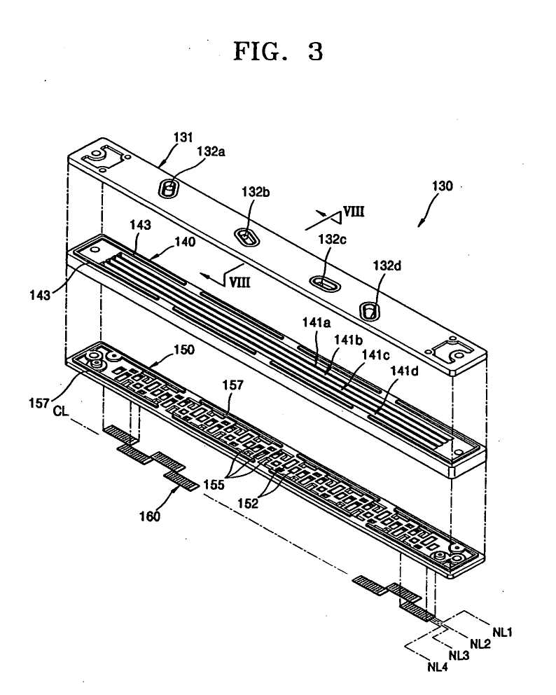

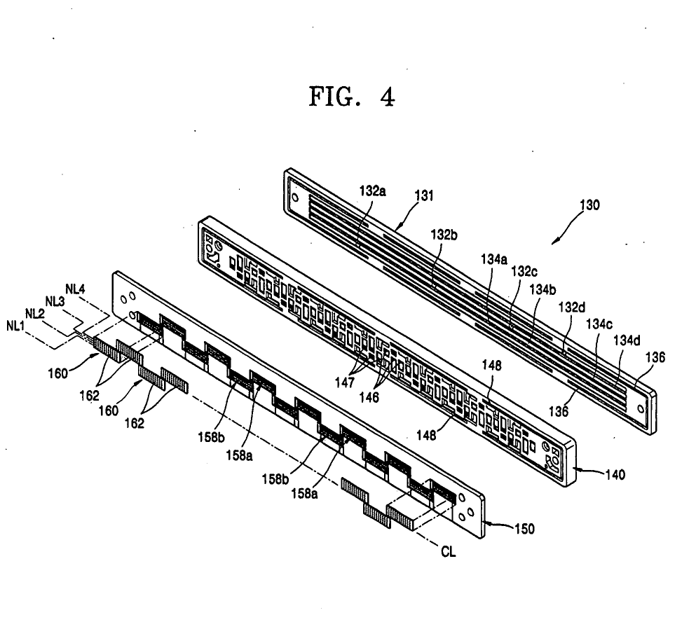

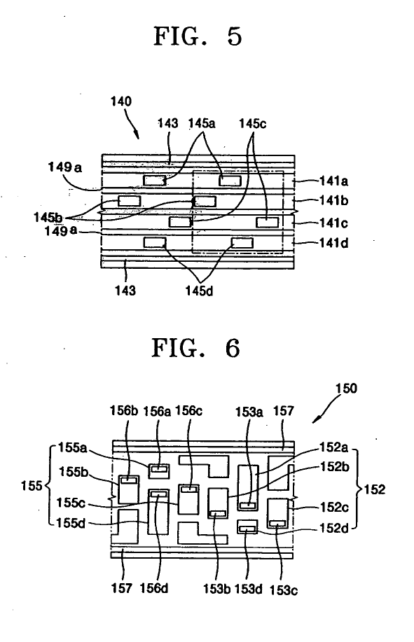

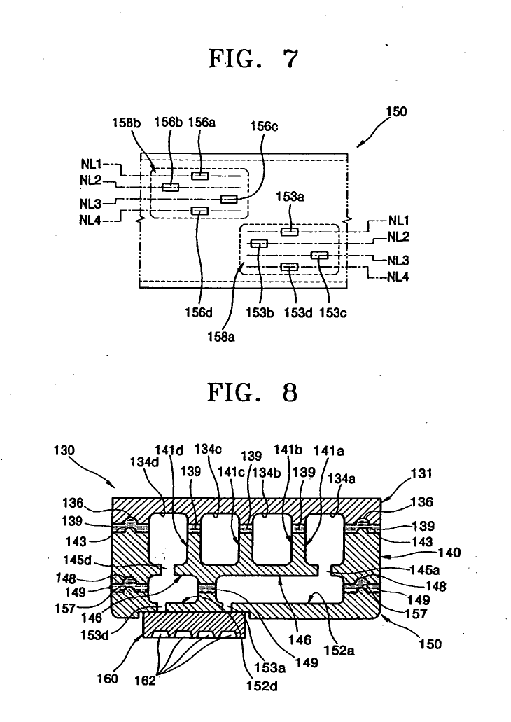

FIGS. 3 and 4 are exploded perspective views the array type printhead 130 of FIG. 2, according to an embodiment of the present general inventive concept. FIG. 3 illustrates a top surface of each element of the array type printhead 130, and FIG. 4 illustrates a bottom surface of each of the elements of the array type printhead 130. FIG. 5 is a plan view partially illustrating a top surface of a second member of the array type printhead 130 illustrated in FIGS. 3 and 4, according to an embodiment of the present general inventive concept. FIG. 6 is a plan view partially illustrating a top surface of a third member illustrated in FIGS. 3 and 4, according to an embodiment of the present general inventive concept, and FIG. 7 is a plan view partially illustrating a bottom surface of the third member of the array type printhead 130 illustrated in FIGS. 3 and 4, according to an embodiment of the present general inventive concept. FIG. 8 is a cross-sectional view illustrating the array type printhead 130 of FIG. 3 taken along line VIII-VIII in FIG. 3.

Referring to FIGS. 3 and 4, the array type printhead 130 to form an image by ejecting ink onto a sheet of printing paper P includes first, second, and third members 131, 140, and 150, which are layered on top of each other, and a plurality of head chips 160 formed on the bottom surface of the third member 150. The first, second, and third members 131, 140, and 150 may be formed by molding a liquid crystal polymer, which is a type of polymer resin. The liquid crystal polymer has a high moldability, chemical resistance, and distortion resistance (e.g., a distortion resistance to an external force), and thus has a high dimensional stability. Therefore, the liquid crystal polymer is suitable for the printhead 130, which requires a high flatness and dimensional precision.

The first member 131 includes first, second, third, and fourth inflow holes 132a, 132b, 132c, and 132d, through which cyan (C) ink, magenta (M) ink, yellow (Y) ink, and black (K) ink that flows from the negative pressure regulators 125C, 125M, 125Y, and 125K, respectively, may flow to an inside of the printhead 130, for example, to first, second, third, and fourth channels 141a, 141b, 141c, and 141d of the second member 140, respectively. For example, cyan (C) ink may flow toward the first channel 141a through the first inflow hole 132a, magenta (M) ink may flow toward the second channel 141b through the second inflow hole 132b, yellow (Y) ink may flow toward the third channel 141c through the third inflow hole 132c, and black (K) ink may flow toward the fourth channel 141d through the fourth inflow hole 132d.

The second member 140 includes the first, second, third, and fourth channels 141a, 141b, 141c, and 141d, which can contain C, M, Y, and K inks, respectively, to flow therethrough from the inflow holes 132a, 132b, 132c, and 132d, respectively. The channels 141a, 141b, 141c, and 141d extend in a widthwise direction of the printing paper P, that is, a lengthwise direction of the printhead 130, and are parallel to each other. For example, the first channel 141a may contain cyan (C) ink, the second channel 141b may contain magenta (M) ink, the third channel 141c may contain yellow (Y) ink, and the fourth channel 141d may contain black (K) ink. First, second, third, and fourth sub-channels 134a, 134b, 134c, and 134d are formed in a bottom surface of the first member 131 on the same manner as the first, second, third, and fourth channels 141a, 141b, 141c, and 141d are formed on the second member 140. According to the above structure, the first, second, third, and fourth sub-channels 134a, 134b, 134c, and 134d of the first member 131 face the first, second, third, and fourth channels 141a, 141b, 141c, and 141d of the second member 140, respectively, as illustrated in FIG. 8, to form an ink-containing space sufficient for each of C, M, Y, and K inks. Thus, even during a full-firing of the array type printhead 130, in which most nozzles 162 of a plurality of nozzles 162 of the head chip 160 simultaneously eject ink onto the printing paper P, a good printing quality can be obtained due to a sufficient supply of ink.

Ribs 143 are formed on edges of the top surface of the second member 140 to protrude from the second member 140, and grooves 136 are formed on edges of the bottom surface of the first member 131 to receive the ribs 143. The first member 131 and the second member 140 are aligned and attached to each other through the ribs 143 and the grooves 136. Also, the ribs 143 and the grooves 136 prevent the first and second members 131 and 140 from being bent and distorted to help seal a space between the first and second members 131 and 140.

Referring to FIG. 5, a plurality of first outflow holes 145a, a plurality of second outflow holes 145b, a plurality of third outflow holes 145c, and a plurality of fourth outflow holes 145d are formed in the channels 141a, 141b, 141c, and 141d of the second member 140, respectively, to permit a flow of the ink to the third member 150. In each of the channels 141a, 141b, 141c, and 141d, the outflows holes 145a, 145b, 145c, and 145d are formed at regular intervals to correspond to a length of the head chip 160. The outflows holes 145a, 145b, 145c, and 145d may be diagonally arranged with respect to each other along entire lengths of the channels 141a, 141b, 141c, and 141d. Inks of four colors may be provided to a single head chip 160 by four outflows holes 145a, 145b, 145c, and 145d, respectively, as indicated by a block illustrated with dot-solid line in FIG. 5. The second member 140 may have one or more dividers 149a formed between the channels to isolate one channel from other channels.

Referring to FIGS. 3 and 4, a plurality of first path grooves 152 and a plurality of second path grooves 155, through which ink from the second member 140 can flow, are formed on the top surface of the third member 150. The plurality of head chips 160 are arranged in the printhead 130 in the widthwise direction of the printing paper P, that is, in the lengthwise direction of the printhead 130, in a zigzag pattern to form a head chip line CL. Accordingly, head chip mounting units 158a and 158b may be formed on the bottom surface of the third member 150 in a zigzag pattern as illustrated in FIG. 7. The head chip mounting unit 158a is located in one side of the head chip line CL in a widthwise direction of the third member 150, and the head chip mounting unit 158b is located in an opposite side of the head chip line CL in the widthwise direction of the third member 150.

Referring to FIG. 6, on the third members 150, the first path grooves 152 may include a first set of path grooves 152a, 152b, 152c, and 152d to provide ink to the head chip mounting unit 158a, and the second path grooves 155 may include a second set of path grooves 155a, 155b, 155c, and 155d to provide ink to the head chip mounting unit 158b. The first and second path grooves 152 and 155 are repeatedly arranged in the third member 150 to correspond to the head chips 160 in the widthwise direction of the printing paper P, that is, the lengthwise direction of the printhead 130. Specifically, the first set of path grooves 152a-152d and the second set of path grooves 155a-155d are alternately arranged. For example, cyan (C) ink from the outflow hole 145a (see FIG. 5) may flow into the path grooves 152a and 155a, magenta (M) ink from the outflow hole 145b may flow into the path grooves 152b and 155b, yellow (Y) ink from the outflow hole 145c may flow into the path grooves 152c and 155c, and black (K) ink from the outflow hole 145d may flow into the path grooves 152d and 155d.

First supply holes 153a, 153b, 153c, and 153d are formed in the first set of path grooves 152a, 152b, 152c, and 152d, respectively, to provide ink to the head chip 160 mounted on the head chip mounting unit 158a, and second supply holes 156a, 156b, 156c, and 156d are formed in the second set of path grooves 155a, 155b, 155c, and 155, respectively, to provide ink to the head chip 160 mounted on the head chip mounting unit 158b.

On the head chip 160, the plurality of nozzles 162 to eject ink form four nozzle lines NL1, NL2, NL3, and NL4 in the widthwise direction of the printing paper P. Referring to FIG. 7, cyan (C) ink may be supplied to the first nozzle line NL1 through the supply holes 153a and 156a, magenta (M) ink may be supplied to the second nozzle line NL2 through the supply holes 153b and 156b, yellow (Y) ink may be supplied to the third nozzle line NL3 through the supply holes 153c and 156c, and black (K) ink may be supplied to the fourth nozzle line NL4 through the supply holes 153d and 156d. Therefore, the nozzles 162 (see FIG. 4) on the first nozzle line NL1 may eject the cyan (C) ink, the nozzles 162 on the second nozzle line NL2 may eject the magenta (M) ink, the nozzles 162 on the third nozzle line NL3 may eject the yellow (Y) ink, and the nozzle 162 on the fourth nozzle line NL4 may eject the black (K) ink.

Referring to FIGS. 3 and 4, a third set of path grooves 146 and a fourth set of path grooves 147 are formed on a bottom surface of the second member 140 in the same pattern that the first and second set of path grooves 152 and 155 are formed on the third member 150.

Ribs 157 are formed on edges of the top surface of the third member 150 to protrude from the third member 150, and grooves 148 are formed on edges of the bottom surface of the second member 140 to receive the ribs 157. The second member 140 and the third member 150 are aligned and attached to each other through the ribs 157 and grooves 148, and the ribs 157 and the grooves 148 prevent the second member 140 and the third member 150 from being bent and distorted and help seal a space between the second member 140 and the third member 150.

Referring to FIG. 8, sealant may be used to seal a space between the first and second members 131 and 140 and a space between the second and third members 140 and 150. Thus, sealant layers 139 and 149 may be formed between the first and second members 131 and 140 and between the second and third members 140 and 150, respectively. The sealant may be composed of, for example, a series of epoxy resins, which have good a adhesion and sealing property.

Although not illustrated, the array type printhead according to the present embodiment may include a plurality of head chip lines, and each head chip line thereof may be formed by a plurality of head chips arranged thereon. The array type printhead including the plurality of head chip lines may print an image faster than the array type printhead having a single head chip line, as illustrated in FIGS. 3 and 4.

According to various embodiments of the present general inventive concept, an array type printhead, which can be molded with a polymer resin, and an inkjet image forming apparatus including the array type printhead, can reduce a manufacturing cost thereof.

Furthermore, according to various embodiments of the present general inventive concept, since a single head chip can eject inks of a plurality of colors, a printhead having a single head chip line can print a color image. Therefore, the inkjet image forming apparatus can be miniaturized.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An array type printhead, comprising:
a first member comprising a plurality of inflow holes through which inks of different colors flow;
a second member comprising a plurality of channels formed on a top surface thereof to receive the inks of different colors from the plurality of inflow holes of the first member, and a plurality of outflow holes through which the received inks flow;
a third member comprising a plurality of path grooves formed on a top surface thereof through which the inks of different colors flow from the second member, and a plurality of supply holes formed in corresponding ones of the plurality of path grooves, each supply hole to supply one head chip nozzle line with ink of one color; and
at least one head chip mounted on a bottom surface of the third member and comprising a plurality of nozzles arranged in a plurality of lines in a lengthwise direction of the printhead corresponding to a widthwise direction of a printing medium to eject the inks of different colors,
wherein the first, second, and third members are layered on top of each other.

2. The array type printhead of claim 1, wherein the first, second, and third members each include at least one polymer resin.

3. The array type printhead of claim 2, wherein the polymer resin is a liquid crystal polymer.

4. The array type printhead of claim 1, wherein the first member comprises a plurality of sub-channels formed on a bottom surface thereof and having an identical pattern as the plurality of channels formed on the top surface of the second member.

5. The array type printhead of claim 1, wherein the second member comprises a plurality of path grooves formed on a bottom surface thereof and having an identical pattern as the plurality of path grooves formed on the top surface of the third member.

6. The array type printhead of claim 1, further comprising:
sealant layers formed between the bottom surface of the first member and the top surface of the second member, and between the bottom surface of the second member and the top surface of the third member, respectively, in order to prevent the inks of different colors from mixing with each other and/or to prevent ink leakage.

7. The array type printhead of claim 6, further comprising:
ribs formed on edge portions of the top surface of the second member and on edge portions of the top surface of the third member to protrude from the second member and the third member, respectively; and
grooves formed on edge portions of the bottom surface of the first member and on edge portions of the bottom surface of the second member to receive the ribs from the second member and the third member, respectively.

8. The array type printhead of claim 1, wherein the plurality of channels of the second member extend in parallel to each other in the lengthwise direction of the printhead.

9. The array type printhead of claim 8, wherein:
the plurality of inflow holes of the first member comprises four inflow holes through each of which inks of four different colors respectively flow to the second member;
the plurality of channels of the second member comprises four channels to receive the inks of four different colors flowing through the four inflow holes, respectively; and
the plurality of nozzles of the at least one head chip comprises four nozzle lines to eject the inks of the four different colors, respectively.

10. The array type printhead of claim 1, wherein:
the at least one head chip comprises a plurality of head chips arranged in the lengthwise direction of the printhead to form a head chip line; and
each of the plurality of channels of the second member comprises one or more outflow holes arranged at regular intervals to correspond to a length of the head chip line.

11. The array type printhead of claim 10, wherein the plurality of path grooves are repeatedly arranged in the third member in the lengthwise direction of the printhead.

12. The array type printhead of claim 10, wherein the plurality of head chips are arranged in a zigzag pattern along the head chip line, and a first set of path grooves to supply ink to a portion of the plurality of head chips arranged in a side of the head chip line and a second set of path grooves to supply ink to a portion of the plurality of head chips arranged in an opposite side of the head chip line are alternately formed in the top surface of the third member.

13. The array type printhead of claim 10, wherein the at least one head chip comprises a plurality of head chip lines on which the plurality of head chips are arranged.

14. An inkjet image forming apparatus, comprising:
a paper conveying unit to convey a printing medium in one direction; and
an array type printhead to eject ink onto the printing medium to form an image thereon, the array type printhead comprising:
a first member comprising a plurality of inflow holes through which inks of different colors flow;
a second member comprising a plurality of channels formed on a top surface thereof to receive the inks of different colors from the plurality of inflow holes of the first member, and a plurality of outflow holes through which the received inks flow;
a third member comprising a plurality of path grooves formed on a top surface thereof through which the inks of different colors flow from the second member, and a plurality of supply holes formed in corresponding ones of the plurality of path grooves, each supply hole to supply one head chip nozzle line with ink of one color; and
at least one head chip mounted on a bottom surface of the third member and comprising a plurality of nozzles arranged in a plurality of lines in a lengthwise direction of the printhead corresponding to a widthwise direction of a printing medium to eject the inks of different colors,
wherein the first, second, and third members are layered on top of each other.

15. The inkjet image forming apparatus of claim 14, wherein the first, second, and third members each include at least one polymer resin.

16. The inkjet image forming apparatus of claim 15, wherein the polymer resin is a liquid crystal polymer.

17. The inkjet image forming apparatus of claim 14, wherein the first member comprises a plurality of channels formed on a bottom surface thereof and having an identical pattern as the plurality of channels formed on the top surface of the second member.

18. The inkjet image forming apparatus of claim 14, wherein the second member comprises a plurality of path grooves formed on a bottom surface thereof and having an identical pattern as the plurality of path grooves formed on the top surface of the third member.

19. The inkjet image forming apparatus of claim 14, further comprising:
sealant layers formed between the bottom surface of the first member and the top surface of the second member, and between the bottom surface of the second member and the top surface of the third member, respectively, in order to prevent the inks of different colors from mixing with each other and/or to prevent ink leakage.

20. The inkjet image forming apparatus of claim 19, further comprising:
ribs formed on edge portions of the top surface of the second member and on edge portions of the top surface of the third member to protrude from the second member and the third member, respectively; and
grooves are formed on edge portions of the bottom surface of the first member and on edge portions of the bottom surface of the second member to receive the ribs from the second member and the third member, respectively.

21. The inkjet image forming apparatus of claim 14, wherein the plurality of channels of the second member extend in parallel to each other in the lengthwise direction of the printhead.

22. The inkjet image forming apparatus of claim 14, wherein:
the plurality of inflow holes of the first member comprises four inflow holes through which inks of four different colors respectively flow to the second member;
the plurality of channels of the second member comprises four channels to receive the ink of four different colors flowing through the four inflow holes, respectively; and
the at least one head chip comprises four nozzle lines to eject the inks of the four different colors, respectively.

23. The inkjet image forming apparatus of claim 22, wherein:
the at least one head chip comprises a plurality of head chips arranged in the lengthwise direction of the printhead to form a head chip line; and
each of the plurality of channels of the second member comprises one or more outflow holes arranged at regular intervals to correspond to a length of the head chip line.

24. The inkjet image forming apparatus of claim 23, wherein the plurality of path grooves is repeatedly arranged in the third member in the lengthwise direction of the printhead.

25. The inkjet image forming apparatus of claim 23, wherein the plurality of head chips are arranged in a zigzag pattern along the head chip line, and a first set of path grooves to supply ink to a portion of the plurality of head chips arranged in a side of the head chip line and a second set of path grooves to supply ink to a portion of the plurality of head chips arranged in an opposite side of the head chip line are alternately formed in the top surface of the third member.

26. The inkjet image forming apparatus of claim 23, wherein the at least one head chip comprises a plurality of head chip lines on which the plurality of head chips are arranged.

27. An array type inkjet printhead useable in an inkjet image forming apparatus, comprising:
a first member comprising a plurality of ink holes to receive corresponding ones of a plurality of differently-colored inks;
a second member comprising a plurality of ink channels to communicate with the plurality of ink holes to receive corresponding ones of the plurality of differently-colored inks;
a third member comprising at least one set of ink grooves to communicate with the plurality of ink channels to receive corresponding ones of the plurality of differently-colored inks; and
at least one head chip comprising a plurality of nozzle lines to communicate with the at least one set of ink grooves to receive and eject corresponding ones of the plurality of differently-colored inks.

28. The array type inkjet printhead of claim 27, wherein the first member further comprises a plurality of ink sub-channels to communicate with corresponding ones of the plurality of ink holes and corresponding ones of the plurality of ink channels of the second member.

29. The array type inkjet printhead of claim 28, further comprising:
a plurality of ink chambers formed by the communication between the plurality of ink sub-channels of the first member and the plurality of ink channels of the second member to contain corresponding ones of the differently-colored inks.

30. An array type inkjet printhead useable in an inkjet image forming apparatus, comprising:
a plurality of storage spaces to store corresponding ones of a plurality of differently-colored inks;
a plurality of outflow holes corresponding to the plurality of storage spaces to allow a flow of the plurality of differently-colored inks from the plurality of storage spaces;
a plurality of ink grooves to receive corresponding ones of the plurality of differently-colored inks from the plurality of outflow holes;
a plurality of supply holes corresponding to the plurality of ink grooves to supply the plurality of differently-colored inks from the plurality of supply holes; and
a head chip comprising a plurality of nozzle lines to communicate with the plurality of supply holes to receive and eject corresponding ones of the plurality of differently-colored inks supplied by the plurality of supply holes.

31. The array type inkjet printhead of claim 45, wherein the plurality of outflow holes are located at predetermined intervals along a length of the printhead corresponding to a length of the head chip.

32. An inkjet ink cartridge useable in an image forming apparatus, comprising:
a plurality of ink tanks to store corresponding ones of a plurality of differently-colored inks;
a plurality of negative pressure regulators corresponding to the plurality of ink tanks to regulate pressures thereof; and
an array type inkjet printhead, comprising:
a first member comprising a plurality of ink holes to receive corresponding ones of the plurality of differently-colored inks from the plurality of ink tanks,
a second member comprising a plurality of ink channels to communicate with the plurality of ink holes to receive corresponding ones of the plurality of differently-colored inks,
a third member comprising at least one set of ink grooves to communicate with the plurality of ink channels to receive corresponding ones of the plurality of differently-colored inks, and
at least one head chip comprising a plurality of nozzle lines to communicate with the at least one set of ink grooves to receive and eject corresponding ones of the plurality of differently-colored inks.

33. A printhead, comprising:
a member having a plurality of inflow holes disposed in a lengthwise direction to receive a plurality of different inks, and a plurality of channels each disposed in the lengthwise direction and connected to corresponding ones of the plurality of inflow holes to direct corresponding ones of the plurality of different inks in the lengthwise direction;
a head chip having a plurality of nozzles; and
another member disposed between the member and the head chip and having pass grooves to guide the different inks from the corresponding channels to the corresponding nozzles in a direction having an angle with the lengthwise direction.

34. The printhead of claim 33, wherein:
the plurality of nozzles comprises a plurality of sets of nozzles, each set of nozzles disposed on a plurality of parallel lines in the lengthwise direction; and
the inflow holes are disposed on the respective parallel lines.

35. The printhead of claim 34, wherein the pass grooves are disposed parallel to each other in the direction to guide the corresponding different inks from the corresponding inflow holes to the corresponding nozzles.

36. The printhead of claim 35, wherein the pass grooves comprise:
a first groove having a first length and a second groove having a second length in the direction.

37. The printhead of claim 36, wherein the first length corresponds to a distance between adjacent ones of the parallel lines, and the second length corresponds to a distance between two of the parallel lines disposed opposite to each other with respect to at least one of the parallel lines therebetween.
